(19) United States
(12) Patent Application Publication
(10) Pub. No.: US 2025/0008389 A1
(43) Pub. Date: Jan. 2, 2025

(54) METHODS AND APPARATUSES FOR SUPPORTING A PSCELL SWITCH PROCEDURE IN A MR-DC SCENARIO

(71) Applicant: LENOVO (BEIJING) LIMITED, Beijing (CN)

(72) Inventors: Congchi ZHANG, Shanghai (CN); Lianhai WU, Beijing (CN); Mingzeng DAI, Shanghai (CN); Le YAN, Shanghai (CN)

(21) Appl. No.: 18/291,076

(22) PCT Filed: Jul. 23, 2021
(86) PCT No.: PCT/CN2021/108186

§ 371 Date: Jan. 22, 2024

(51) Int. Cl. H04W 36/00

(52) U.S. Cl. CPC H04W 36/00698; H04W 36/0061

(57) ABSTRACT

Embodiments of the present application relate to methods and apparatuses for a primary secondary cell (PSCell) switch procedure in a multi-radio dual connectivity (MR-DC) scenario under a 3rd Generation Partnership Project (3GPP) 5G system or the like. According to an embodiment of the present application, a method can be performed by a user equipment (UE) in a MR-DC scenario and can include: transmitting capability information of the UE to a network, wherein the capability information indicates that the UE supports a PSCell switch procedure to switch from a source PSCell to a target PSCell; receiving configuration information from the network; performing the PSCell switch procedure based on the received configuration information, to switch from the source PSCell to the target PSCell; and transmitting information regarding the target PSCell to the network.

### TECHNICAL FIELD

Embodiments of the present application generally relate to wireless communication technology, especially to methods and apparatuses for a primary secondary cell (PSCell) switch procedure in a multi-radio dual connectivity (MR-DC) scenario.

### BACKGROUND

Next generation radio access network (NG-RAN) supports a MR-DC operation. In the MR-DC operation, a user equipment (UE) with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3GPP standard documents), and at least the MN is connected to the core network.

The 3rd Generation Partnership Project (3GPP) 5G system or network adopts a MRO mechanism. However, details regarding a PSCell switch procedure in a MR-DC scenario have not been discussed in 3GPP 5G technology yet.

### SUMMARY

Some embodiments of the present application provide a method performed by a UE in a MR-DC scenario. The method includes: transmitting capability information of the UE to a network, wherein the capability information indicates that the UE supports a PSCell switch procedure to switch from a source PSCell to a target PSCell; receiving configuration information from the network; performing the PSCell switch procedure based on the received configuration information, to switch from the source PSCell to the target PSCell; and transmitting information regarding the target PSCell to the network.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE in a MR-DC scenario.

Some embodiments of the present application also provide a UE in a MR-DC scenario. The UE includes a processor and a wireless transceiver coupled to the processor; and the processor is configured: to transmit, via the wireless transceiver, capability information of the UE to a network, wherein the capability information indicates that the UE supports a PSCell switch procedure to switch from a source PSCell to a target PSCell; to receive, via the wireless transceiver, configuration information from the network; to perform the PSCell switch procedure based on the received configuration information, to switch from the source PSCell to the target PSCell; and to transmit, via the wireless transceiver, information regarding the target PSCell to the network.

Some embodiments of the present application provide a method performed by a MN in a MR-DC scenario. The method includes: receiving, from a UE, capability information of the UE, wherein the capability information indicates that the UE supports a PSCell switch procedure to switch from a source PSCell to a target PSCell; and transmitting an indicator associated with the capability information to a SN, wherein the SN is communicatively coupled to the MN.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a MN in a MR-DC scenario.

Some embodiments of the present application also provide a MN in a MR-DC scenario. The MN includes a processor and a wireless transceiver coupled to the processor; and the processor is configured: to receive, via the wireless transceiver from a UE, capability information of the UE, wherein the capability information indicates that the UE supports a PSCell switch procedure to switch from a source PSCell to a target PSCell; and transmit, via the wireless transceiver, an indicator associated with the capability information to a SN, wherein the SN is communicatively coupled to the MN.

Some embodiments of the present application provide a method performed by a SN in a MR-DC scenario. The method includes: receiving, from a MN, an indicator associated with capability information of a UE, wherein the capability information indicates that the UE supports a PSCell switch procedure to switch from a source PSCell to a target PSCell, and wherein the MN is communicatively coupled to the SN; and transmitting, to the MN, configuration information for use during the PSCell switch procedure.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method performed by a SN in a MR-DC scenario.

Some embodiments of the present application also provide a SN in a MR-DC scenario. The SN includes a processor and a wireless transceiver coupled to the processor; and the processor is configured: to receive, via the wireless transceiver from a MN, an indicator associated with capability information of a UE, wherein the capability information indicates that the UE supports a PSCell switch procedure to switch from a source PSCell to a target PSCell, and wherein the MN is communicatively coupled to the SN; and to transmit, via the wireless transceiver to the MN, configuration information for use during the PSCell switch procedure.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates a schematic diagram of a UE configured with more than one secondary cell group (SCG) in accordance with some embodiments of the present application;

FIG. 3 illustrates a schematic diagram of inter-cell Layer1/Layer2 (L1/L2) mobility in accordance with some embodiments of the present application;

FIG. 4 illustrates an exemplary flowchart of performing a PSCell switch procedure in accordance with some embodiments of the present application;

FIG. 5 illustrates an exemplary flowchart of receiving information regarding a PSCell switch procedure in accordance with some embodiments of the present application;

FIG. 6 illustrates a further exemplary flow chart of receiving information regarding a PSCell switch procedure in accordance with some embodiments of the present application;

FIG. 7 illustrates an exemplary flowchart of requesting configuration of a PSCell switch procedure in accordance with some embodiments of the present application;

FIG. 8 illustrates an exemplary flowchart of providing configuration of a PSCell switch procedure in accordance with some embodiments of the present application;

FIG. 9 illustrates an exemplary flowchart of a MN initiated PSCell switch procedure in accordance with some embodiments of the present application;

FIG. 10 illustrates an exemplary flowchart of a UE initiated PSCell switch procedure in accordance with some embodiments of the present application; and

FIG. 11 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

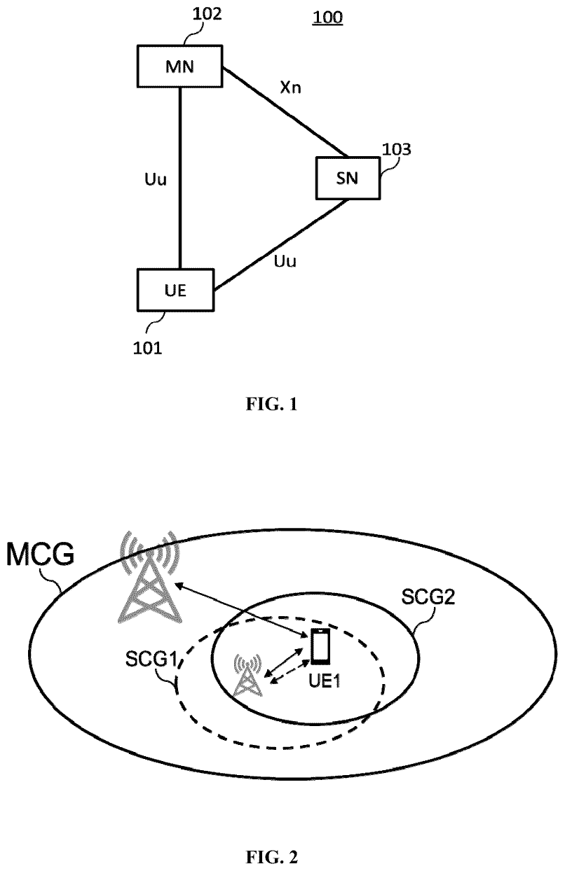

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a MCG. The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

FIG. 2 illustrates a schematic diagram of a UE configured with more than one secondary cell group (SCG) in accordance with some embodiments of the present application.

As shown in FIG. 2, UE1 is configured with two SCGs, i.e., SCG1 and SCG2. UE1 may communicate with MCG and these two SCGs. In some embodiments, in a PSCell switch procedure, UE1 may switch from a PSCell in SCG1 to a PSCell in SCG2, or switch from a PSCell in SCG2 to a PSCell in SCG1. In some further embodiments, in a PSCell switch procedure, UE1 may switch from a PSCell in SCG1 to another PSCell in SCG1, or switch from a PSCell in SCG2 to another PSCell in SCG2.

In 3GPP release 17, in a non-MRDC scenario, it has been discussed to support an inter-cell mobility based on Layer1/Layer2 (L1/L2) signaling. In particular, a UE can be provided in advance with configurations from multiple cells, and a BS (e.g., gNB) may switch a UE to a new cell using L1/L2 signaling taking into account the received physical layer measurement result. In accordance with 3GPP standard document, a BS may consist of a BS-centralized unit (CU) and one or more BS-distributed unit(s) (DU(s)). A BS-CU and a BS-DU are connected via F1 interface which is a logical interface. One BS-DU is connected to only one BS-CU.

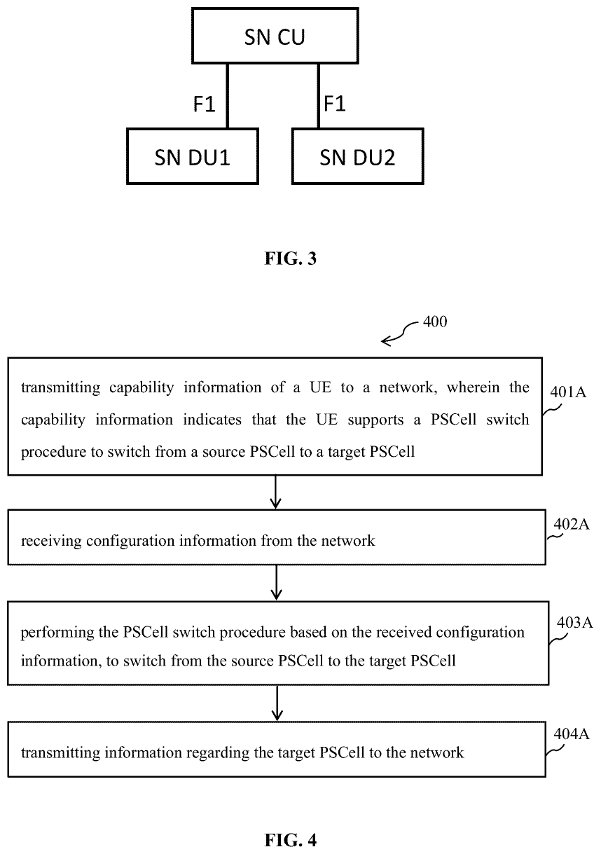

FIG. 3 illustrates a schematic diagram of inter-cell Layer1/Layer2 (L1/L2) mobility in accordance with some embodiments of the present application. As shown in FIG. 3, SN CU may communicate with two SN DUs, i.e., SN DU1 or SN DU2, via F1 interfaces. SN CU in FIG. 3 may implement legacy mobility decision based on Layer 3 (L3) measurement result. SN DU1 or SN DU2 in FIG. 3 may implement L1/L2 mobility decision based on physical layer measurement result.

Compared to legacy L3 mobility, L1/L2 mobility is considered faster with less processing delay and signaling delay. In legacy L3 mobility, a SN CU (e.g., SN CU as shown in FIG. 3) makes the mobility decision based on received radio resource management (RRM) measurement report. Different than legacy L3 mobility, in L1/L2 mobility, a SN DU (e.g., SN DU1 or SN DU2 as shown in FIG. 3) makes the mobility decision based on physical layer measurement result, e.g., carried in a channel state information (CSI) report. Besides, in legacy L3 mobility, the handover command is sent via an RRC message from the SN CU to a UE, while in L1/L2 mobility, the “handover” command is sent via L1/L2 signaling (e.g., downlink control information (DCI) or a medium access control (MAC) control element (CE)) from the SN DU to a UE. The “handover” command in L1/L2 mobility can be about cell activation or deactivation, e.g., activate a new serving PCell while deactivate the old serving PCell.

In a legacy MR-DC scenario, a UE is configured with a MCG connection to a MN and a SCG connection to a SN. In case of any problem happens to the SCG connection, e.g., according to L3 RRM measurement, a network might decide to reconfigure the SCG, e.g., to instruct a UE to change the PSCell and corresponding SCG. The legacy PSCell change is done based on L3 measurement result and L3 signaling procedure, which is considered to be latency heavy especially considering the signaling exchange between a MN and a SN. Thus, it is considered beneficial to support an intra SN PSCell switch procedure or an intra SN SCG switch procedure based on L1 or L2 measurement result and signaling. In particular, a UE can be provided in advance with configurations from multiple PSCells or multiple SCGs, and the PSCell/SCG switch decision is made considering a physical layer measurement result. The PSCell/SCG switch decision can be made by a SN DU or a UE according to some given execution condition.

Currently, an issue of how to support an intra SN PSCell/SCG switch procedure has been solved. Embodiments of the present application provide details regarding an intra SN PSCell/SCG switch procedure when considering following factors: (1) an interaction between a MN and a SN over Xn interface to provide PSCell/SCG related configurations; (2) an interaction between a SN DU and a SN CU over F1 interface upon a PSCell/SCG switch decision and an execution; and (3) an interaction between a network and a UE upon a PSCell/SCG switch procedure initiated by a UE.

In particular, some embodiments of the present application provide an intra SN fast PSCell/SCG switch procedure in a MR-DC scenario in 3GPP 5G system or the like. In some embodiments of the present application, a MN and a SN coordinate to prepare candidate PSCell(s) or candidate SCG(s) for a fast PSCell/SCG switch purpose (to distinguish from other scenarios, such as, a conditional PSCell addition and change (CPAC) scenario). In some embodiments of the present application, for a network initiated fast PSCell/SCG switch procedure, a SN DU informs a SN CU about the PSCell/SCG switch decision and successful information regarding a PSCell/SCG switch procedure. In some embodiments of the present application, for a UE initiated fast PSCell/SCG switch procedure, in case that a new SCG is deactivated and a UE does not perform a random access (RA) procedure after a PSCell/SCG switch decision, the UE informs the network about the PSCell/SCG switch decision via a MCG. In some embodiments of the present application, a SN DU always keeps a SN CU and a MN CU updated about the new serving PSCell/SCG after successfully completing the fast PSCell/SCG switch procedure.

In the embodiments of the present application, the term “serving” PSCell/SCG and “non-serving” PSCell/SCG mean as following:
(1) Serving PSCell/SCG: a PSCell/SCG that can be activated or deactivated. When activated, a UE can transmit UL data or receive DL data via the serving PSCell/SCG.
(2) Non-Serving PSCell/SCG: when PSCell/SCG is a non-serving PSCell/SCG, it cannot be used to transmit UL data or receive DL data. In other words, a UE can be configured with some non-serving PSCell/SCG, but cannot use it for data receiving/transmitting unless it becomes a serving PSCell/SCG.

In some embodiments of the present application, “a PSCell switch procedure” may also be named as “a PSCell/SCG switch procedure”, “a fast PSCell/SCG switch procedure”, or the like. More details will be illustrated in following text in combination with the appended drawings.

FIG. 4 illustrates an exemplary flowchart of performing a PSCell switch procedure in accordance with some embodiments of the present application. The exemplary method 400 in the embodiments of FIG. 4 may be performed by a UE (e.g., UE 101, UE1, UE 210, UE 310, UE 410, or UE 510 as shown and illustrated in any of FIGS. 1, 2, and 7-10). Although described with respect to a UE, it should be understood that other devices may be configured to perform a method similar to that of FIG. 4. The embodiments of FIG. 4 assume that the UE is in a MR-DC scenario. In the embodiments of FIG. 4, only intra-SN mobility scenario is considered. Intra SN mobility means that a MCG connection to a MN remains the same, while a UE may change a PSCell and the corresponding SCG within the same SN due to mobility.

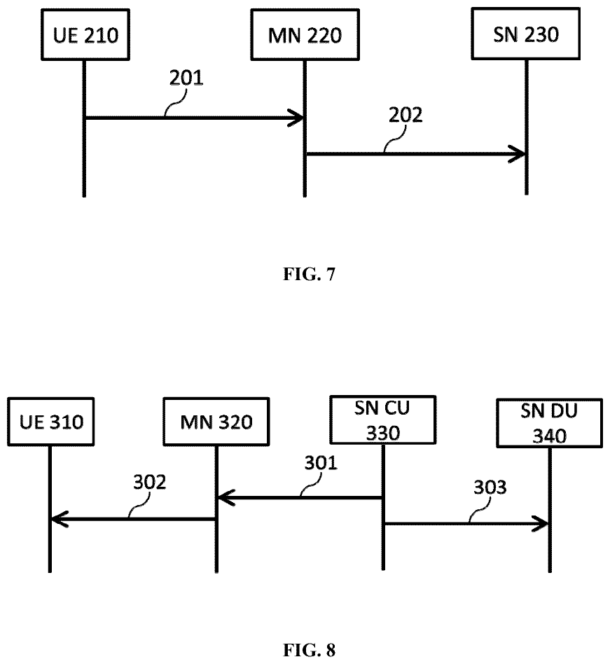

In the exemplary method 400 as shown in FIG. 4, in operation 401A, a UE (e.g., UE 101 as shown and illustrated in FIG. 1) transmits capability information of the UE to a network. The capability information may indicate that the UE supports a PSCell switch procedure to switch from a source PSCell to a target PSCell. In some embodiments, the capability information indicates a maximum number of candidate PSCell(s) or a maximum number of candidate SCG(s) which can be supported by the UE. Specific examples are described in embodiments of FIG. 7 as below.

According to some embodiments, the source PSCell and the target PSCell belong to one SCG, i.e., the same SCG. According to some other embodiments, the source PSCell and the target PSCell belong to two different SCGs. That is, the source and target PSCell/SCG may belong to the same or different DU of the same SN. In some embodiments, if the source PSCell is in an activated state, the target PSCell is in the activated state. In some further embodiments, if the source PSCell is in a deactivated state, the target PSCell is in the deactivated state. In some other embodiments, the target PSCell is by default in an activated state.

Referring back to FIG. 4, in operation 402A, the UE receives configuration information from the network. In an embodiment, the configuration information includes configuration regarding candidate SCG(s), and each candidate SCG is associated with one PSCell. In a further embodiment, the configuration information includes configuration regarding one SCG. This SCG may be associated with two or more candidate PSCells. Specific examples are described in embodiments of FIG. 8 as below. In some embodiments, the configuration information includes at least one of:
(1) An explicit indicator associated with a SCG which indicates whether the SCG is a serving SCG.
(2) An explicit indicator associated with the SCG which indicates whether the SCG is a non-serving SCG.
(3) An activation indication associated with the SCG.
(4) A deactivation indication associated with the SCG.
(5) An explicit indicator associated with a PSCell/SCG which indicates whether it is a serving PSCell.
(6) An explicit indicator associated with the PSCell/SCG which indicates whether it is a non-serving PSCell.
(7) Execution condition(s) of the PSCell/SCG switch procedure.
(8) PSCell(s) prepared by a SN in the MR-DC scenario (e.g., SN 103 as shown and illustrated in FIG. 1).
(9) SCG(s) prepared by the SN.
(10) Serving PSCell(s) prepared by the SN.
(11) Serving SCG(s) prepared by the SN.
(12) An activated or deactivated state of serving PSCell(s) prepared by the SN.
(13) An activated or deactivated state of serving SCGs(s) prepared by the SN.

In operation 403A as shown in FIG. 4, the UE performs the PSCell switch procedure based on the received configuration information, to switch from the source PSCell to the target PSCell. In operation 404A as shown in FIG. 4, the UE transmits information regarding the target PSCell to the network.

According to some embodiments, the UE further selects the target PSCell according to the configuration information, and transmits a PSCell switch decision to the network. The PSCell switch decision may explicitly or implicitly indicate an identity (ID) of the target PSCell. According to some other embodiments, the UE further selects the target SCG according to the configuration information, and transmits a SCG switch decision to the network. The SCG switch decision may explicitly or implicitly indicate an ID of the target SCG.

According to some embodiments, the UE may decide to perform the PSCell switch procedure according to a physical layer measurement result of the UE. Specific examples are described in embodiments of FIG. 10 as below.

Details described in all other embodiments of the present application (for example, details of a PSCell switch procedure in a MR-DC scenario) are applicable for the embodiments of FIG. 4. Moreover, details described in the embodiments of FIG. 4 are applicable for all the embodiments of FIGS. 1-3 and 5-11.

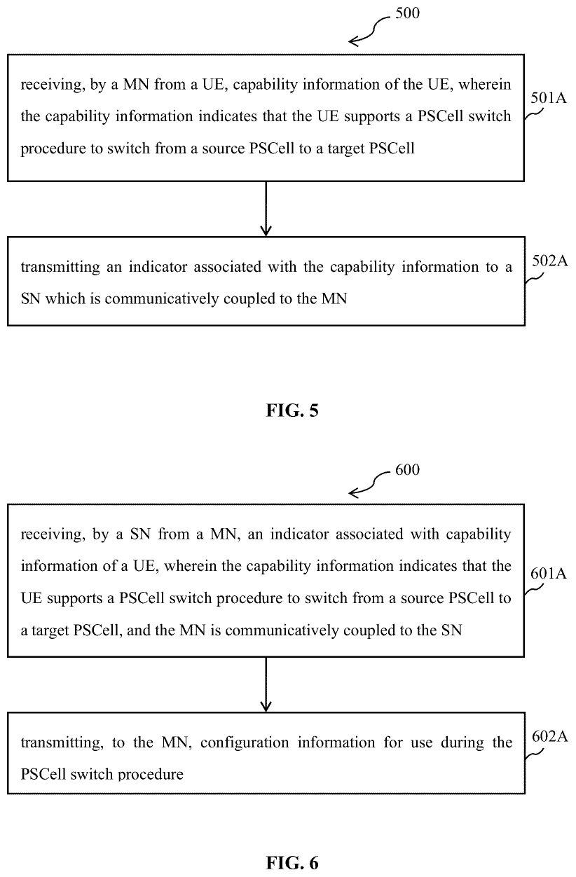

FIG. 5 illustrates an exemplary flowchart of receiving information regarding a PSCell switch procedure in accordance with some embodiments of the present application. The exemplary method 500 in the embodiments of FIG. 5 may be performed by a MN (e.g., MN 102, MN 3220, MN 320, MN 450, or MN 550 as shown and illustrated in any of FIGS. 1 and 7-10). Although described with respect to a MN, it should be understood that other devices may be configured to perform a method similar to that of FIG. 5. The embodiments of FIG. 5 assume that a MN and a SN may be combined in any one of EN-DC, NGEN-DC, NE-DC, and NR-DC scenarios.

In the exemplary method 500 as shown in FIG. 5, in operation 501A, a MN (e.g., MN 102 as shown and illustrated in FIG. 1) receives capability information of a UE (e.g., UE 101 as shown and illustrated in FIG. 1) from the UE. The capability information indicates that the UE supports a PSCell switch procedure to switch from a source PSCell to a target PSCell. In some embodiments, if the source PSCell is in an activated state, the target PSCell is in the activated state. In some further embodiments, if the source PSCell is in a deactivated state, the target PSCell is in the deactivated state. In some other embodiments, the target PSCell is by default in an activated state.

In operation 502A as shown in FIG. 5, the MN transmits an indicator associated with the capability information to a SN (e.g., SN 103 as shown and illustrated in FIG. 1) which is communicatively coupled to the MN. The indicator may be transmitted in a SN addition request message or a SN modification request message. According to some embodiments, the indicator transmitted in operation 501A is at least one of:
(1) an explicit information element (IE) which indicates that the PSCell switch procedure can be supported;
(2) a capability ID of the UE which implies that the PSCell switch procedure is supported by the UE;
(3) a maximum number of candidate PSCell(s) which can be prepared by the SN;
(4) a maximum number of candidate SCG(s) which can be prepared by the SN; and
(5) one or more cells each of which is prepared as a PSCell of a candidate SCG.

According to some embodiments, the MN receives, from the SN, configuration information for use during the PSCell switch procedure. In an embodiment, the MN further transmits a RRC message including the configuration information to the UE. Specific examples are described in embodiments of FIG. 8 as below.

In some embodiments, the configuration information is received in a SN addition request acknowledge message or a SN modification request acknowledge message. In an embodiment, the configuration information includes configuration regarding candidate SCG(s), and each candidate SCG is associated with one PSCell. In a further embodiment, the configuration information includes configuration regarding one SCG, and this SCG is associated with two or more candidate PSCells. The configuration information in the embodiments of FIG. 5 may include similar contents to those of the configuration information in the embodiments of FIG. 4.

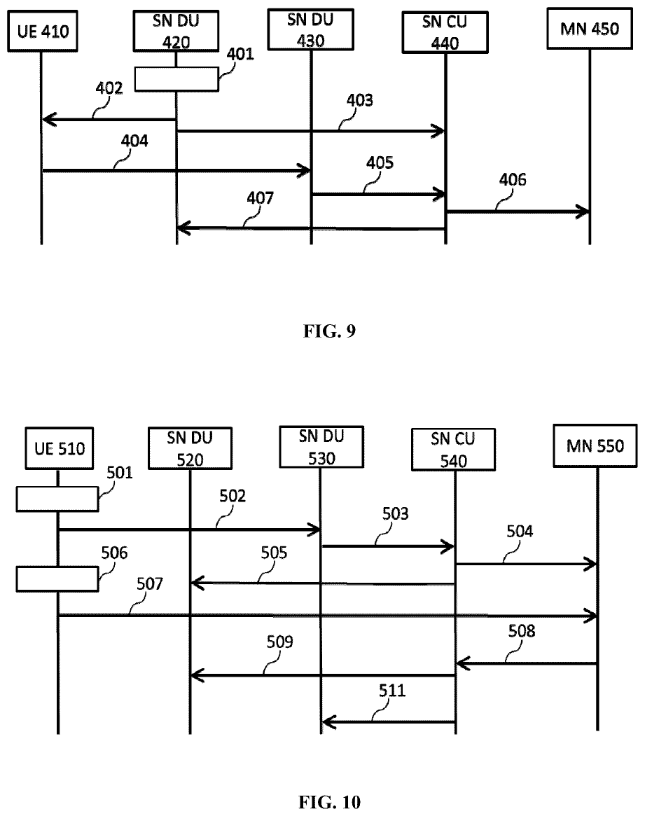

According to some embodiments, the MN receives, from the SN, a message including successful information of the PSCell switch procedure. The successful information may explicitly or implicitly indicate an ID of the target PSCell or a target SCG of the PSCell switch procedure. For example, the message is a SN modification required message. Specific examples are described in embodiments of FIGS. 9 and 10 as below.

According to some embodiments, the MN receives a PSCell switch decision or a SCG switch decision from the UE. The PSCell switch decision may explicitly or implicitly indicate an ID of the target PSCell of the PSCell switch procedure. The SCG switch decision may explicitly or implicitly indicate an ID of a target SCG of the PSCell switch procedure. According to some embodiments, the MN further transmits the PSCell switch decision or the SCG switch decision to the SN. According to some embodiments, the MN further transmits a PSCell switch command or a SCG switch command to the UE via Layer 1 signaling or Layer 2 signaling. Specific examples are described in embodiments of FIG. 10 as below.

Details described in all other embodiments of the present application (for example, details of a PSCell switch procedure in a MR-DC scenario) are applicable for the embodiments of FIG. 5. Moreover, details described in the embodiments of FIG. 5 are applicable for all the embodiments of FIGS. 1-4 and 6-11.

FIG. 6 illustrates a further exemplary flow chart of receiving information regarding a PSCell switch procedure in accordance with some embodiments of the present application. The exemplary method 600 in the embodiments of FIG. 6 may be performed by a SN (e.g., SN 103, SN CU, SN DU1, SN DU2, SN 230, SN CU 330, SN DU 340, SN DU 420, SN DU 430, SN CU 440, SN DU 520, SN DU 530, or SN CU 540, as shown and illustrated in any of FIGS. 1, 3, and 7-10). Although described with respect to a SN, it should be understood that other devices may be configured to perform a method similar to that of FIG. 6. The embodiments of FIG. 6 assume that a MN and a SN may be combined in any one of EN-DC, NGEN-DC, NE-DC, and NR-DC scenarios.

In the exemplary method 600 as shown in FIG. 6, in operation 601A, a SN (e.g., SN 103 as shown and illustrated in FIG. 1) receives, from a MN (e.g., MN 102 as shown and illustrated in FIG. 1) which is communicatively coupled to the SN, an indicator associated with capability information of a UE (e.g., UE 101 as shown and illustrated in FIG. 1). The indicator may be received in a SN addition request message or a SN modification request message. The capability information may indicate that the UE supports a PSCell switch procedure to switch from a source PSCell to a target PSCell.

According to some embodiments, the source PSCell and the target PSCell belong to one DU of the SN associated with a CU of the SN. According to some other embodiments, the source PSCell and the target PSCell belong to two different DUs of the SN associated with the CU of the SN. In some embodiments, if the source PSCell is in an activated state, the target PSCell is in the activated state. In some further embodiments, if the source PSCell is in a deactivated state, the target PSCell is in the deactivated state. In some other embodiments, the target PSCell is by default in an activated state.

According to some embodiments, the indicator received in operation 601A is at least one of:
(1) an explicit IE which indicates that the PSCell switch procedure can be supported;
(2) a capability ID of the UE which implies that the PSCell switch procedure is supported by the UE;
(3) a maximum number of candidate PSCell(s) which can be prepared by the SN;
(4) a maximum number of candidate SCG(s) which can be prepared by the SN; and
(5) one or more cells each of which is prepared as a PSCell of a candidate SCG.

According to some embodiments, in response to receiving the maximum number of candidate PSCell(s) or the maximum number of candidate SCG(s), and in response to not receiving a conditional primary cell of a second cell group (PSCell) addition and change (CPAC) indicator, the SN may consider that the maximum number of candidate PSCell(s) or the maximum number of candidate SCG(s) is for the PSCell switch procedure.

Referring back to FIG. 6, in operation 602A, the SN transmits, to the MN, configuration information for use during the PSCell switch procedure. The configuration information may be transmitted in a SN addition request acknowledge message or a SN modification request acknowledge message. According to some embodiments, the configuration information includes configuration regarding candidate SCG(s), and each candidate SCG is associated with one PSCell. According to some other embodiments, the configuration information includes configuration regarding one SCG which is associated with two or more candidate PSCells. Specific examples are described in embodiments of FIG. 8 as below. The configuration information in the embodiments of FIG. 6 may include similar contents to those of the configuration information in the embodiments of FIG. 4.

In some embodiments, if a CU of the SN transmits the configuration information to the MN, the CU of the SN may transmit a message, which includes the configuration information, to a DU of the SN. The message may be a UE context setup request message or a UE context modification request message. In an embodiment, the CU of the SN may further receive, from the DU of the SN, an occurrence indicator of the PSCell switch procedure. For example, the occurrence indicator may be included in at least one of: (1) a UE context modification required message; (2) a UE context modification required message; and (3) an assistance information data message.

According to some embodiments, the SN receives, from the MN, a maximum number of SCG(s) that can be configured as a serving SCG. In response to not receiving the maximum number of SCG(s) that can be configured as the serving SCG, the SN may consider that only one SCG can be configured as the serving SCG. According to some embodiments, the SN further receives, from the MN, information indicating an activated or deactivated state of the serving SCG.

In some embodiments, one DU of the SN, which is associated with the target PSCell, receives a random access (RA) request or a data packet from the UE. In response to receiving the RA request or the data packet, the DU of the SN may transmit successful information of the PSCell switch procedure to a CU of the SN. Specific examples are described in embodiments of FIGS. 9 and 10 as below. For instance, the successful information may explicitly or implicitly indicate an ID of the target PSCell or an ID of the target SCG of the PSCell switch procedure. The successful information may be included in at least one of: (1) a UE context modification required message; (2) a UE context modification required message; and (3) an assistance information data message.

In an embodiment, in response to receiving the successful information from the DU of the SN, the CU of the SN may transmit, to the MN, a message which includes the successful information of the PSCell switch procedure. For example, the message is a SN modification required message. In a further embodiment, in response to receiving the successful information from the DU of the SN, the CU of the SN may transmit, to another DU of the SN which is associated with the source PSCell, the successful information of the PSCell switch procedure.

According to some embodiments, the SN receives a PSCell switch decision or a SCG switch decision from the MN. The PSCell switch decision may explicitly or implicitly indicate an ID of a target PSCell of the PSCell switch procedure. The SCG switch decision may explicitly or implicitly indicate an ID of a target SCG of the PSCell switch procedure. In an embodiment, if the PSCell switch decision or the SCG switch decision is received by a CU of the SN, the CU of the SN may transmit, to a DU of the SN, successful information of the PSCell switch procedure. Specific examples are described in embodiments of FIG. 10 as below.

Details described in all other embodiments of the present application (for example, details of a PSCell switch procedure in a MR-DC scenario) are applicable for the embodiments of FIG. 6. Moreover, details described in the embodiments of FIG. 6 are applicable for all the embodiments of FIGS. 1-5 and 7-11.

FIG. 7 illustrates an exemplary flowchart of requesting configuration of a PSCell switch procedure in accordance with some embodiments of the present application. In the embodiments of FIG. 7, to achieve a PSCell switch procedure, a network (e.g., MN 220 or SN 230) will provide configuration of multiple candidate SCGs to UE 210 before a SCG switch command is sent via, e.g., L1/L2 signaling.

In step 201 as shown in FIG. 7, UE 210 indicates, to MN 220, any or a combination of following (e.g., as a part of capability information of UE 210): (1) whether a PSCell switch procedure can be supported; and (2) a maximum number of candidate PSCell(s)/SCG(s) can be supported. Then, MN 220 may understand whether a PSCell switch procedure can be supported based on information provided from UE 210.

In step 202 as shown in FIG. 7, MN 220 indicates, to the peer SN (i.e., SN 230), that a PSCell switch procedure is supported by UE 210 during Xn SN addition/modification procedure by adding new indicator(s) in the corresponding SN addition request or SN modification request Xn message. The new indicator(s) can be any or a combination of following:
(1) A new explicit IE indicating that a PSCell switch procedure can be supported.
(2) A capability ID of UE 210 implying that a PSCell switch procedure is supported by the UE 210.
(3) A maximum number of candidate PSCell(s) or candidate SCG(s) which can be prepared. In an embodiment, when a maximum number of candidate PSCell(s)/SCG(s) can be prepared is provided to SN 330, and if there is no legacy CPAC indicator in the same SN addition/modification request message, SN 330 deduces that this is a maximum number of candidate PSCell(s)/SCG(s) for a PSCell switch procedure, instead of a maximum number of candidate PSCell(s)/SCG(s) for a CPAC procedure. Currently, in 3GPP release 17 CPAC, a SN will be provided with a maximum number of PSCell(s) to be prepared together with a CPAC indicator indicating this is for a CPAC procedure.
(4) A list of one or more cells in which each cell shall be prepared as a PSCell of a candidate SCG.

In some embodiments of FIG. 7, MN 220 may also indicate, to SN 230, a maximum number of SCG(s) that can be configured as serving SCG(s). MN 220 may determine a total number of serving SCGs which can be configured simultaneously according to the capability of UE 210, e.g., a number of transmission (TX) chains. If the maximum number of serving SCG(s) is not provided, SN 230 considers that only one SCG can be configured as serving SCG by default.

In some embodiments of FIG. 7, MN 220 may also indicate, to SN 230, the activated/deactivated state of the serving SCG. The activated/deactivated state is applicable for all serving SCGs prepared by SN 230.

Details described in all other embodiments of the present application (for example, details of a PSCell switch procedure in a MR-DC scenario) are applicable for the embodiments of FIG. 7. Moreover, details described in the embodiments of FIG. 7 are applicable for all the embodiments of FIGS. 1-6 and 8-11.

FIG. 8 illustrates an exemplary flowchart of providing configuration of a PSCell switch procedure in accordance with some embodiments of the present application.

In the embodiments of FIG. 8, upon accepting a SN addition/modification request and knowing a PSCell switch procedure can/shall be supported by UE 310, SN CU 330 provides configuration for the PSCell switch procedure to MN 320, in step 301 as shown in FIG. 8. In one example, RRC configuration for the PSCell switch procedure may be provided in a SN addition/modification request acknowledge Xn message to MN 320. In a further example, configuration for the PSCell switch procedure may be provided in a F1 control plane message. Then, in step 302 as shown in FIG. 8, MN 320 forwards the configuration for the PSCell switch procedure to UE 310.

In some embodiments of FIG. 8, when providing the configuration for a PSCell switch procedure via RRC or F1 control plane message, SN CU 330 may provide configuration of a list of candidate SCG(s). The configuration for each candidate SCG may be associated with one PSCell and optionally multiple SCells. UE 310 can understand whether a configured SCG is a serving SCG via one of following:
(1) Explicit indicator associated with the SCG configuration whether it is a serving SCG.
(2) Explicit indicator associated with the SCG configuration whether it is a non-serving SCG.
(3) If the SCG configuration contains (de) activation indication (i.e., if the SCG shall be activated or deactivated), it is a serving SCG.

Following Table 1 and Table 2 are specific examples of FIG. 8. Table 1 defines a cell group (CG)-Config message. Table 2 defines a “CellGroupConfig” information element (IE).

TABLE 1
CG-Config message

-- ASN1START
-- TAG-CG-CONFIG-START

| | |
|---|---|
| CG-Config ::= | SEQUENCE { |

| | |
|---|---|
| criticalExtensions | CHOICE { |

| | |
|---|---|
| c1 | CHOICE{ |

| | |
|---|---|
| cg-Config | CG-Config-IEs, |

spare3 NULL, spare2 NULL, spare1 NULL

| }, | | | | | | | | |
|---|---|---|---|---|---|---|---|---|
| criticalExtensionsFuture | | | SEQUENCE { } | | | | | |
| } | | | | | | | | |
| } | | | | | | | | |
| CG-Config-IEs ::= | | SEQUENCE { | | | | | | |
| serving-SCG-indicator | | Boolean | | | | | | |
| OPTIONAL, | | | | | | | | |
| scg-CellGroupConfig | | | | OCTET STRING (CONTAINING | | | | |
| RRCReconfiguration) | OPTIONAL, | | | | | | | |
| scg-RB-Config | | | | OCTET STRING (CONTAINING | | | | |
| RadioBearerConfig) | OPTIONAL, | | | | | | | |
| configRestrictModReq | | | | | ConfigRestrictModReqSCG | | | |
| OPTIONAL, | | | | | | | | |
| drx-InfoSCG | | | | | | | | DRX-Info |
| OPTIONAL, | | | | | | | | |
| candidateCellInfoListSN | | | | OCTET STRING (CONTAINING | | | | |
| MeasResultList2NR) | OPTIONAL, | | | | | | | |
| measConfigSN | | | | | | | MeasConfigSN | |
| OPTIONAL, | | | | | | | | |
| selectedBandCombination | | | | | BandCombinationInfoSN | | | |
| OPTIONAL, | | | | | | | | |
| fr-InfoListSCG | | | | | | | FR-InfoList | |
| OPTIONAL, | | | | | | | | |
| candidateServingFreqListNR | | | | CandidateServingFreqListNR | | | | |
| OPTIONAL, | | | | | | | | |
| nonCriticalExtension | | | | | | CG-Config-v1540-IEs | | |
| OPTIONAL | | | | | | | | |
| } | | | | | | | | |

TABLE 2
CellGroupConfig information element

-- ASN1START
-- TAG-CELLGROUPCONFIG-START
-- Configuration of one Cell-Group:

| CellGroupConfig ::= | | SEQUENCE { | | | | |
|---|---|---|---|---|---|---|
| cellGroupId | | | CellGroupId, | | | |
| rlc-BearerToAddModList | | | | | | SEQUENCE |
| (SIZE(1..maxLC-ID)) | OF | | | | RLC-BearerConfig | |
| OPTIONAL, -- Need N | | | | | | |
| rlc-BearerToReleaseList | | | | | | SEQUENCE |
| (SIZE(1..maxLC-ID)) OF LogicalChannelIdentity | | | | | | OPTIONAL, |
| -- Need N | | | | | | |
| mac-CellGroupConfig | | | | MAC-CellGroupConfig | | |
| OPTIONAL, -- Need M | | | | | | |
| physicalCellGroupConfig | | | | PhysicalCellGroupConfig | | |
| OPTIONAL, -- Need M | | | | | | |
| spCellConfig | | | | | | SpCellConfig |
| OPTIONAL, -- Need M | | | | | | |
| sCellToAddModList | | | | | SEQUENCE (SIZE | |
| (1..maxNrofSCells)) OF SCellConfig | | | | | OPTIONAL, -- | |
| Need N | | | | | | |
| sCellToReleaseList | | | | | SEQUENCE (SIZE | |
| (1..maxNrofSCells)) OF SCellIndex | | | | | OPTIONAL, -- | |
| Need N | | | | | | |
| ..., | | | | | | |
| ]], | | | | | | |

| | |
|---|---|
| reportUplinkTxDirectCurrent | ENUMERATED {true} |

OPTIONAL -- Cond BWP-Reconfig

| ]], | | | | | |
|---|---|---|---|---|---|
| [[ | | | | | |
| bap-Address-r16 | | BIT STRING (SIZE (10)) | | | |
| OPTIONAL, -- Need M | | | | | |
| bh-RLC-ChannelToAddModList-r16 | | | | | SEQUENCE |
| (SIZE(1..maxBH-RLC-ChannelID-r16)) | OF | BH-RLC-ChannelConfig-r16 | | | |
| OPTIONAL, -- Need N | | | | | |
| bh-RLC-ChannelToReleaseList-r16 | | | | | SEQUENCE |
| (SIZE(1..maxBH-RLC-ChannelID-r16)) | OF | | BH-RLC-ChannelID-r16 | | |
| OPTIONAL, -- Need N | | | | | |
| flc-TransferPath-r16 | | ENUMERATED {lte, nr, both} | | | |
| OPTIONAL, -- Need M | | | | | |
| simultaneousTCI-UpdateList1-r16 | | | | SEQUENCE (SIZE | |
| (1..maxNrofServingCellsTCI-r16)) OF ServCellIndex | | | | OPTIONAL, -- | |
| Need R | | | | | |
| simultaneousTCI-UpdateList2-r16 | | | | SEQUENCE (SIZE | |
| (1..maxNrofServingCellsTCI-r16)) OF ServCellIndex | | | | OPTIONAL, -- | |
| Need R | | | | | |
| simultaneousSpatial-UpdatedList1-r16 | | | SEQUENCE (SIZE | | |
| (1..maxNrofServingCellsTCI-r16)) OF ServCellIndex | | | | OPTIONAL, -- | |
| Need R | | | | | |
| simultaneousSpatial-UpdatedList2-r16 | | | SEQUENCE (SIZE | | |
| (1..maxNrofServingCellsTCI-r16)) OF ServCellIndex | | | | OPTIONAL, -- | |
| Need R | | | | | |
| uplinkTxSwitchingOption-r16 | | ENUMERATED {switchedUL, | | | |
| dualUL} | | | OPTIONAL, -- Need | | |
| R | | | | | |
| uplinkTxSwitchingPowerBoosting-r16 | | ENUMERATED {enabled} | | | |
| OPTIONAL -- Need R | | | | | |
| ]] | | | | | |
| } | | | | | |

-- Serving cell specific MAC and PHY parameters for a SpCell:

| SpCellConfig ::= | SEQUENCE { | |
|---|---|---|
| servCellIndex | | ServCellIndex |
| OPTIONAL, -- Cond SCG | | |

servPSCellIndicator Boolean

OPTIONAL

| | |
|---|---|
| reconfigurationWithSync | ReconfigurationWithSync |

OPTIONAL, -- Cond ReconfWithSync

| rlf-TimersAndConstants | | | | SetupRelease |
|---|---|---|---|---|
| { RLF-TimersAndConstants } | OPTIONAL, -- Need M | | | |
| rlmInSyncOutOfSyncThreshold | | ENUMERATED {n1} | | |
| OPTIONAL, -- Need S | | | | |
| spCellConfigDedicated | | | ServingCellConfig | |
| OPTIONAL, -- Need M | | | | |
| ... | | | | |
| } | | | | |

In some other embodiments of FIG. 8, when providing the configuration for a PSCell switch procedure via RRC or F1 control plane message, SN CU 330 may only provide one set of SCG configuration. There may be multiple candidate PSCells and optionally multiple SCells contained in the set of SCG configuration. In these embodiments, UE 310 can understand whether a PSCell is a serving PSCell via one of following:
(1) Explicit indicator associated with the PSCell configuration whether it is a serving PSCell.
(2) Explicit indicator associated with the PSCell configuration whether it is a non-serving PSCell.

In some embodiments of FIG. 8, SN CU 330 may also indicate any or a combination of following to MN 320 within the SN addition/modification request acknowledge Xn message:
(1) List of PSCells/SCGs prepared by the SN.
(2) List of serving PSCells/SCGs prepared by the SN.
(3) Activation/deactivation state of the prepared serving PSCells/SCGs by the SN.

In an embodiment of FIG. 8, for each candidate PSCell/SCG, SN CU 330 may also generate and provide a corresponding execution condition. In this case, in on example, UE 310 may switch from an old serving PSCell/SCG to a new PSCell/SCG, if the old serving PSCell/SCG link quality does not fit the execution condition and the new serving PSCell/SCG link quality fits the execution condition.

In step 303 as shown in FIG. 8, SN CU 330 also provides the PSCell switch related configuration to SN DU 340 via a UE CONTEXT SETUP REQUEST message or a UE CONTEXT MODIFICATION REQUEST message over F1 interface. SN DU 340 may be associated with any candidate PSCell/SCG.

Details described in all other embodiments of the present application (for example, details of a PSCell switch procedure in a MR-DC scenario) are applicable for the embodiments of FIG. 8. Moreover, details described in the embodiments of FIG. 8 are applicable for all the embodiments of FIGS. 1-7 and 9-11.

FIG. 9 illustrates an exemplary flowchart of a MN initiated PSCell switch procedure in accordance with some embodiments of the present application.

In step 401 as shown in FIG. 9, when a current SCG is activated, SN DU 420 may decide to switch UE 410 from one PSCell/SCG to another PSCell/SCG which has been configured according to the embodiments of FIGS. 7 and 8. The abovementioned another (new) PSCell/SCG may be by default activated. The old PSCell/SCG and the new PSCell/SCG can belong to the same or different SN DU associated with the same SN CU.

In step 402 as shown in FIG. 9, SN DU 420 sends a PSCell/SCG switch command to UE 410 via L1/L2 signaling (e.g., DCI or a MAC CE). In step 403 as shown in FIG. 9, upon sending the PSCell/SCG switch command to UE 410, SN DU 420 informs the associated SN CU 440 about the execution of the PSCell/SCG switch procedure via any or a combination of following ways:
(1) Indicating the target PSCell/SCG in the F1 control plane UE CONTEXT MODIFICATION REQUIRED message, as specified in 3GPP standard document TS38.473.
(2) Indicating the occurrence of the PSCell/SCG switch procedure in the F1 control plane UE CONTEXT MODIFICAITON REQUIRED message, as specified in 3GPP standard document TS38.473, without indicating the target PSCell/SCG, e.g., the current PSCell/SCG stops data transmission/reception
(3) Indicating the occurrence of the PSCell/SCG switch procedure in the F1 user plane ASSISTANCE INFORMATION DATA, as specified in 3GPP standard document TS38.473, e.g., the current PSCell/SCG stops data transmission/reception.

In step 404 as shown in FIG. 9, upon receiving the PSCell/SCG switch command from SN DU 420, UE 410 starts a RA procedure or sends a data packet directly to the new PSCell associated with the new SCG. When SN DU 430 associated with the new PSCell/SCG receives a RA request or a data packet from UE 410, SN DU 430 understands the occurrence of the PSCell/SCG switch procedure. Upon the successful PSCell/SCG switch procedure, UE 410 may keep the candidate PSCell(s)/SCG(s) configurations.

In step 405 as shown in FIG. 9, after successfully completing the RA procedure to the new PSCell/SCG, the associated SN DU 430 informs SN CU 440 about the successful PSCell switch procedure. SN DU 430 may inform SN CU 440 about the execution of the PSCell/SCG switch procedure via any or a combination of following ways:
(1) Indicating the target PSCell/SCG in the F1 control plane UE CONTEXT MODIFICATION REQUIRED message.
(2) Indicating the occurrence of PSCell/SCG switch in the F1 control plane UE CONTEXT MODIFICAITON REQUIRED message without indicating the target PSCell/SCG, e.g., the current PSCell/SCG stops data transmission/reception.
(3) Indicating the occurrence of PSCell/SCG switch in the F1 user plane ASSISTANCE INFORMATION DATA, e.g., the current PSCell/SCG stops data transmission/reception.

In step 406 as shown in FIG. 9, upon the successful PSCell/SCG switch procedure, SN CU 440 informs MN 450 about the successful PSCell/SCG switch procedure via Xn signaling. For example, SN CU 440 can indicate an ID of the new PSCell/SCG in the SN modification required message. In step 407 as shown in FIG. 9, upon the successful PSCell/SCG switch, SN CU 440 informs SN DU 430 associated with the source PSCell/SCG about the successful PSCell/SCG switch via F1 signaling.

Details described in all other embodiments of the present application (for example, details of a PSCell switch procedure in a MR-DC scenario) are applicable for the embodiments of FIG. 9. Moreover, details described in the embodiments of FIG. 9 are applicable for all the embodiments of FIGS. 1-8, 10, and 11.

FIG. 10 illustrates an exemplary flowchart of a UE initiated PSCell switch procedure in accordance with some embodiments of the present application. The embodiments of FIG. 10 assume that UE 510 is configured in advance with a set of candidate PSCell(s)/SCG(s), each of which is associated with an execution condition.

In step 501 as shown in FIG. 10, UE 510 decides which PSCell/SCG to connect to according to the physical layer measurement result. In step 502 as shown in FIG. 10, UE 510 transmits a random access request or a data packet to SN DU 530. When SN DU 530 associated with the new PSCell/SCG receives the random access or data packet from UE 510, SN DU 530 may understand the successful PSCell/SCG switch procedure initiated by UE 510.

In step 503 as shown in FIG. 10, SN DU 530 informs SN CU 540 about the successful PSCell switch procedure. SN DU 530 may inform SN CU 540 about the execution of the PSCell/SCG switch procedure via any or a combination of following ways:
(1) Indicating the target PSCell/SCG in the F1 control plane UE CONTEXT MODIFICATION REQUIRED message.
(2) Indicating the occurrence of PSCell/SCG switch in the F1 control plane UE CONTEXT MODIFICAITON REQUIRED message without indicating the target PSCell/SCG, e.g., the current PSCell/SCG stops data transmission/reception.
(3) Indicating the occurrence of PSCell/SCG switch in the F1 user plane ASSISTANCE INFORMATION DATA, e.g., the current PSCell/SCG stops data transmission/reception.

In step 504 as shown in FIG. 10, upon the successful UE initiated PSCell/SCG switch procedure, SN CU 540 informs MN 550 about the successful PSCell/SCG switch procedure via Xn signaling. For example, SN CU 540 can indicate the new PSCell/SCG ID in the SN modification required message.

In step 505 as shown in FIG. 10, upon the successful PSCell/SCG switch procedure, SN CU 540 informs the SN DU 520 associated with the source PSCell/SCG about the PSCell/SCG switch procedure via F1 signaling. If the old PSCell/SCG is deactivated, the new PSCell/SCG is thus deactivated, and UE 510 does not perform a RA procedure to the new PSCell/SCG.

In step 506 as shown in FIG. 10, upon deciding to switch PSCell/SCG according to the relevant configuration and the execution condition, UE 510 determines whether to perform a random access channel (RACH) to the new PSCell/SCG according to the (de) activation state of the old PSCell/SCG. The new PSCell/SCG may inherit the PSCell/SCG (de) activation state from the old PSCell/SCG. If the old PSCell/SCG is activated, the new PSCell/SCG is thus activated, and UE 510 may perform a RA procedure or send a data packet directly to the new PSCell/SCG. Upon the successful PSCell/SCG switch procedure, UE 510 may keep the candidate PSCells/SCGs configurations and relevant execution conditions.

In step 507 as shown in FIG. 10, if UE 510 has applied the new PSCell/SCG configuration before the PSCell/SCG switch procedure occurs, UE 510 informs MN 550 about the PSCell/SCG switch decision, e.g., by RRC signaling via a MCG leg to MN 550. The RRC signaling may indicate an ID of the new PSCell/SCG selected by UE 510. Then, in step 508 as shown in FIG. 10, MN 550 forwards the PSCell/SCG switch decision to SN CU 540.

In a legacy CPAC procedure, a UE applies the new SCG configuration upon execution, and will send SN RRCReconfigurationComplete message to a MN, no matter the new SCG is activated or not. So, the MN or the SN is aware of the new PSCell/SCG. However, in case of a UE initiated PSCell/SCG switch procedure, it could happen that the UE applies the new SCG configuration before an execution of the SCG switch procedure, and thus, the UE will not send a SN RRC complete message. In this case, if the UE does not perform a RA procedure to the new SCG (e.g., which is deactivated), the network might not be able to know which PSCell/SCG is selected by the UE.

In steps 509 and 511 as shown in FIG. 10, upon the successful PSCell/SCG switch procedure, SN CU 540 informs SN DU 520 associated with the source PSCell/SCG and SN DU 530 associated with the target PSCell/SCG about the PSCell/SCG switch procedure via F1 signaling, respectively.

Details described in all other embodiments of the present application (for example, details of a PSCell switch procedure in a MR-DC scenario) are applicable for the embodiments of FIG. 10. Moreover, details described in the embodiments of FIG. 10 are applicable for all the embodiments of FIGS. 1-9 and 11.

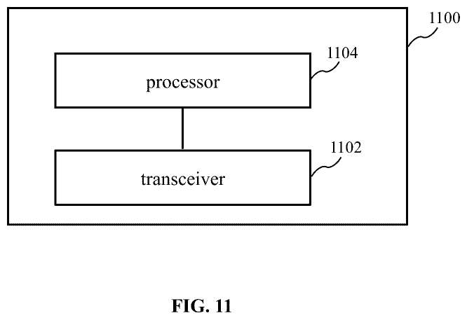

FIG. 11 illustrates an exemplary block diagram of an apparatus according to some embodiments of the present application. As shown in FIG. 11, the apparatus 1100 may include at least one processor 1104 and at least one transceiver 1102 coupled to the processor 1104. The apparatus 1100 may be a UE or a network device (e.g., a MN or a SN) in a MR-DC scenario.

Although in this figure, elements such as the at least one transceiver 1102 and processor 1104 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE in a MR-DC scenario. The transceiver 1102 in the UE may be configured to transmit, via the wireless transceiver, capability information of the UE to a network, and the capability information indicates that the UE supports a PSCell switch procedure to switch from a source PSCell to a target PSCell. The transceiver 1102 in the UE may be configured to receive, via the wireless transceiver, configuration information from the network. The processor 1104 may be configured to perform the PSCell switch procedure based on the received configuration information, to switch from the source PSCell to the target PSCell. The transceiver 1102 in the UE may be further configured to transmit, via the wireless transceiver, information regarding the target PSCell to the network.

In some embodiments of the present application, the apparatus 1100 may be a MN in a MR-DC scenario. The transceiver 1102 in the MN may be configured: to receive, via the wireless transceiver from a UE, capability information of the UE, wherein the capability information indicates that the UE supports a PSCell switch procedure to switch from a source PSCell to a target PSCell; and to transmit, via the wireless transceiver, an indicator associated with the capability information to a SN which is communicatively coupled to the MN.

In some embodiments of the present application, the apparatus 1100 may be a SN in a MR-DC scenario. The transceiver 1102 in the SN may be configured: to receive, via the wireless transceiver from a MN which is communicatively coupled to the SN, an indicator associated with capability information of a UE, wherein the capability information indicates that the UE supports a PSCell switch procedure to switch from a source PSCell to a target PSCell; and to transmit, via the wireless transceiver to the MN, configuration information for use during the PSCell switch procedure.

In some embodiments of the present application, the apparatus 1100 may further include at least one non-transitory computer-readable medium. In some embodiments of the present disclosure, the non-transitory computer-readable medium may have stored thereon computer-executable instructions to cause a processor to implement the method with respect to a UE or a network device (e.g., a MN or a SN) in a MR-DC scenario as described above. For example, the computer-executable instructions, when executed, cause the processor 1104 interacting with transceiver 1102, so as to perform operations of the methods, e.g., as described in view of any of FIGS. 4-10.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1.-15. (canceled)

16. A user equipment (UE) in a multi-radio dual connectivity (MR-DC) scenario, the UE comprising:
a processor; and
a memory coupled with the processor, the processor configured to cause the UE to:
transmit capability information of the UE to a network,
wherein the capability information indicates that the UE supports a primary secondary cell (PSCell) switch procedure to switch from a source PSCell to a target PSCell;
receive configuration information from the network;
perform the PSCell switch procedure, based on the received configuration information, to switch from the source PSCell to the target PSCell; and
transmit information regarding the target PSCell to the network.

17. A master node (MN) in a multi-radio dual connectivity (MR-DC) scenario, the MN comprising:
a processor; and
a memory coupled with the processor, the processor configured to cause the UE to:
receive, from a user equipment (UE), capability information of the UE, wherein the capability information indicates that the UE supports a primary secondary cell (PSCell) switch procedure to switch from a source PSCell to a target PSCell; and
transmit an indicator associated with the capability information to a secondary node (SN), wherein the SN is communicatively coupled to the MN.

18. A secondary node (SN) in a multi-radio dual connectivity (MR-DC) scenario, the SN comprising:
a processor; and
a memory coupled with the processor, the processor configured to cause the UE to:
receive, from a master node (MN), an indicator associated with capability information of a user equipment (UE), wherein the capability information indicates that the UE supports a primary secondary cell (PSCell) switch procedure to switch from a source PSCell to a target PSCell, and wherein the MN is communicatively coupled to the SN; and
transmit, to the MN, configuration information for use during the PSCell switch procedure.

19. The SN of claim 18, wherein the indicator is at least one of:
an explicit information element (IE) indicating that the PSCell switch procedure can be supported;
a capability identifier (ID) of the UE implying that the PSCell switch procedure is supported by the UE;
a maximum number of candidate PSCells can be prepared by the SN;
a maximum number of candidate secondary cell groups (SCGs) can be prepared by the SN; and
one or more cells, wherein each cell within the one or more cells is prepared as a PSCell of a candidate SCG.

20. The SN of claim 19, wherein the processor is further configured to cause the SN to:
in response to receiving the maximum number of candidate PSCells or the maximum number of candidate SCGs, and in response to not receiving a conditional primary cell of a second cell group (PSCell) addition and change (CPAC) indicator, considering that the maximum number of candidate PSCells or the maximum number of candidate SCGs is for the PSCell switch procedure.

21. The SN of claim 18, wherein the processor is further configured to cause the SN to:
receive, from the MN, a maximum number of secondary cell groups (SCGs) that can be configured as a serving SCG.

22. The SN of claim 18, wherein the configuration information includes one of:
configuration information regarding one or more candidate secondary cell groups (SCGs), wherein each candidate SCG within the one or more candidate SCGs is associated with one PSCell; and
configuration information regarding one SCG, wherein the one SCG is associated with two or more candidate PSCells.

23. The SN of claim 18, wherein the configuration information includes at least one of:
an explicit indicator associated with a secondary cell group (SCG) indicating whether the SCG is a serving SCG;
an explicit indicator associated with the SCG indicating whether the SCG is a non-serving SCG;
an activation indication associated with the SCG;
a deactivation indication associated with the SCG;
an explicit indicator associated with a PSCell indicating whether it is a serving PSCell;
an explicit indicator associated with the PSCell indicating whether it is a non-serving PSCell;
one or more execution conditions of the PSCell switch procedure;
one or more PSCells prepared by the SN;
one or more SCGs prepared by the SN;
one or more serving PSCells prepared by the SN;
one or more serving SCGs prepared by the SN;
an activated or deactivated state of the serving PSCells prepared by the SN; and
an activated or deactivated state of the serving SCGs prepared by the SN.

24. The SN of claim 18, wherein the processor is further configured to cause the SN to:
receive, by a centralized unit (CU) of the SN and from a first distributed unit (DU) of the SN, an occurrence indicator of the PSCell switch procedure after the first DU sends a PSCell switch command to the UE.

25. The SN of claim 18, wherein:
in response to the source PSCell being in an activated state, the target PSCell is in the activated state; or
in response to the source PSCell being in a deactivated state, the target PSCell is in the deactivated state; or
the target PSCell is by default in the activated state.

26. The SN of claim 18, wherein the processor is further configured to cause the SN to:
receive a random access (RA) request or a data packet by a second distributed unit (DU) of the SN from the UE; and
in response to receiving the RA request or the data packet, transmit, by the second DU of the SN to a centralized unit (CU) of the SN, successful information of the PSCell switch procedure,
wherein the second DU of the SN is associated with the target PSCell.

27. The SN of claim 26, wherein the processor is further configured to cause the SN to:
in response to receiving the successful information from the second DU of the SN, transmit, by the CU of the SN to the MN, a message including the successful information.

28. A processor for wireless communication in a multi-radio dual connectivity (MR-DC) scenario, the processor comprising:
at least one controller coupled with at least one memory and configured to cause the processor to:
receive, from a master node (MN), an indicator associated with capability information of a user equipment (UE), wherein the capability information indicates that the UE supports a primary secondary cell (PSCell) switch procedure to switch from a source PSCell to a target PSCell, and wherein the MN is communicatively coupled to the SN; and
transmit, to the MN, configuration information for use during the PSCell switch procedure.

29. The processor of claim 28, wherein the indicator is at least one of:
an explicit information element (IE) indicating that the PSCell switch procedure can be supported;
a capability identifier (ID) of the UE implying that the PSCell switch procedure is supported by the UE;
a maximum number of candidate PSCells can be prepared by the processor;
a maximum number of candidate secondary cell groups (SCGs) can be prepared by the processor; and
one or more cells, wherein each cell within the one or more cells is prepared as a PSCell of a candidate SCG.

30. The processor of claim 29, wherein the controller is further configured to cause the processor to:
in response to receiving the maximum number of candidate PSCells or the maximum number of candidate SCGs, and in response to not receiving a conditional primary cell of a second cell group (PSCell) addition and change (CPAC) indicator, considering that the maximum number of candidate PSCells or the maximum number of candidate SCGs is for the PSCell switch procedure.

31. The processor of claim 28, wherein the controller is further configured to cause the processor to:
receive, from the MN, a maximum number of secondary cell groups (SCGs) that can be configured as a serving SCG.

32. The processor of claim 28, wherein the configuration information includes one of:
configuration information regarding one or more candidate secondary cell groups (SCGs), wherein each candidate SCG within the one or more candidate SCGs is associated with one PSCell; and
configuration information regarding one SCG, wherein the one SCG is associated with two or more candidate PSCells.

33. The processor of claim 28, wherein the configuration information includes at least one of:
an explicit indicator associated with a secondary cell group (SCG) indicating whether the SCG is a serving SCG;
an explicit indicator associated with the SCG indicating whether the SCG is a non-serving SCG;
an activation indication associated with the SCG;
a deactivation indication associated with the SCG;
an explicit indicator associated with a PSCell indicating whether it is a serving PSCell;
an explicit indicator associated with the PSCell indicating whether it is a non-serving PSCell;
one or more execution conditions of the PSCell switch procedure;
one or more PSCells prepared by the processor;
one or more SCGs prepared by the processor;
one or more serving PSCells prepared by the processor;
one or more serving SCGs prepared by the processor;
an activated or deactivated state of the serving PSCells prepared by the processor; and
an activated or deactivated state of the serving SCGs prepared by the processor.

34. The processor of claim 28, wherein the controller is further configured to cause the processor to:
receive, by a centralized unit (CU) of the processor and from a distributed unit (DU) of the processor, an occurrence indicator of the PSCell switch procedure.

35. The processor of claim 28, wherein:
in response to the source PSCell being in an activated state, the target PSCell is in the activated state; or
in response to the source PSCell being in a deactivated state, the target PSCell is in the deactivated state; or
the target PSCell is by default in the activated state.
